(19) United States
(12) Patent Application Publication
(10) Pub. No.: US 2020/0393281 A1
(43) Pub. Date: Dec. 17, 2020

(54) BOTTLE WITH DISPENSER

(71) Applicant: Green Roads of Florida LLC., Deanfield Beach, FL (US)

(72) Inventor: Matthew Spencer Haimm, Fort Lauderdale, FL (US)

(21) Appl. No.: 16/900,077

(22) Filed: Jun. 12, 2020

Related U.S. Application Data
(60) Provisional application No. 62/861,082, filed on Jun. 13, 2019.

(51) Int. Cl. G01F 11/02; A61J 1/20

(52) U.S. Cl. CPC G01F 11/027; A61J 1/2096

(57) ABSTRACT

A bottle, jar, decanter, vial, or other vessel with a dispenser apparatus integrated into a lid or cap designed and operative to engage an open top of the bottle is disclosed. The dispenser may be integrated with a structure of the cap, and may be configured and operative selectively to draw liquid from the reservoir and selectively to dispense liquid when the dispenser is disengaged from the open top of the reservoir.

### CROSS-REFERENCE TO RELATED APPLICATION

This application claims the benefit of U.S. provisional patent application Ser. No. 62/861,082, entitled “Bottle With Dispenser,” filed Jun. 13, 2019, the disclosure of which is hereby incorporated herein by reference in its entirety.

### FIELD OF THE DISCLOSURE

This disclosure relates generally to bottles which hold liquid, and more particularly to a bottle with a dispenser apparatus integrated into a lid or cap designed and operative to engage an open top of the bottle.

### BACKGROUND

A variety of bottles, jars, decanters, vial, and other containers are available today for holding liquid. Some bottles include dispenser mechanisms or devices for controlling the extraction of the liquid and administering the liquid as may be appropriate. Most commonly are droppers or pipette-type apparatus (such as eye droppers, for example) built into the underside of the bottle cap. Typically, such droppers are used to extract liquid from the bottle through suction, and then the droppers may be used to dispense the liquid as appropriate. Conventional droppers are often inefficient, however, and ineffective for controlling a measured dosage of the liquid, as may be required in medical applications, for example. The inefficiency of state of the art dropper mechanisms is particularly problematic in situations in which the liquid has a high viscosity. Sometimes bottles are marketed or sold in connection with a separate component, such as a syringe, which can more accurately measure liquid dosages than a conventional dropper. For many manufacturers and consumers, however, having a syringe as a separate component (i.e., discrete from or independent of a bottle) is inconvenient for packaging and storage, increases costs and hassle, and is potentially dangerous to children who have easy access to the syringe and may use it improperly or for an improper purpose.

### SUMMARY

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the disclosed subject matter in a simplified form as a prelude to the more detailed description that is presented later.

The present disclosure describes a system and method employing a dispenser mechanism or apparatus integrated into a lid or cap which is designed and operative to engage an open top of a bottle, jar, decanter, vial, or other vessel holding a liquid. Integrating the dispenser into a structure of the bottle cap prevents stray components from falling into the hands of children, for instance, and ensures that a user will always have access to the dispenser when a dosage of the liquid maintained in the bottle is necessary or desired.

In accordance with one aspect of the disclosed subject matter, for example, a bottle may generally comprise: a reservoir for storing liquid, the reservoir having an open top; and a cap dimensioned and operative to engage the open top of the reservoir such that the cap prevents liquid from escaping the reservoir when the cap is engaged; and a dispenser integrated with a structure of the cap, the dispenser comprising: a plunger; and a tube having a distal end to receive the plunger and a nozzle opposite the distal end; wherein the tube is the dimensioned to extend from the structure of the cap through the open top and into the reservoir, and wherein the plunger reciprocates in the tube, selectively to draw liquid from the reservoir when the plunger is moved away from the nozzle and selectively to dispense liquid from the tube when the cap is disengaged from the open top and the plunger is moved towards the nozzle.

A bottle is disclosed wherein the cap comprises an attachment portion to engage the open top of the reservoir; alternatively, a bottle is disclosed wherein the tube comprises the attachment portion. In some implementations, the attachment portion engages the open top of the reservoir via friction fit; alternatively, the attachment portion comprises threads operative to engage cooperating threads on the open top of the reservoir.

Implementations are disclosed wherein the tube comprises indicia to indicate an amount of liquid in the tube; additionally or alternatively, the plunger comprises indicia to indicate an amount of liquid in the tube. As set forth in more detail below, the reservoir and the tube respectively may be constructed of a material selected from one of the following: glass; metal; ceramic; and plastic.

In some implementations, a bottle may further comprise a wiping mechanism to remove excess liquid from the tube when the dispenser is removed from the reservoir. Embodiments are disclosed wherein the wiping mechanism is integrated into a structure of the reservoir. Embodiments are set forth below wherein the wiping mechanism comprises flexible wedges dimensioned to engage an exterior wall of the tube; in alternative embodiments, the wiping mechanism comprises an o-ring dimensioned to engage an exterior wall of the tube. The wiping mechanism may be constructed of rubber, may be constructed of silicone, or may be constructed of some other suitably flexible material selected as an application-specific design choice.

In accordance with another aspect of the disclosed subject matter, for example, a bottle may generally comprise: a reservoir for storing liquid, the reservoir having an open top; and a cap dimensioned and operative to engage the open top of the reservoir such that the cap prevents liquid from escaping the reservoir when the cap is engaged; and a dispenser integrated with a structure of the cap, the dispenser comprising: means for drawing liquid from the reservoir and for dispensing liquid when the dispenser is disengaged from the open top of the reservoir; and means for indicating an amount of liquid that has been drawn from the reservoir.

Implementations are disclosed wherein the means for drawing and for dispensing comprises: a plunger; and a tube having a distal end to receive the plunger and a nozzle opposite the distal end; wherein the tube is the dimensioned to extend from the structure of the cap through the open top and into the reservoir, and wherein the plunger reciprocates in the tube, selectively to draw liquid from the reservoir when the plunger is moved away from the nozzle and selectively to dispense liquid from the tube when the plunger is moved towards the nozzle.

In some embodiments, the cap comprises attachment means to engage the open top of the reservoir; in some instances, the attachment means may comprise threads operative to engage cooperating threads on the open top of the reservoir. As set forth below, embodiments are disclosed wherein the means for indicating comprises measurement indicia disposed on the tube; additionally or alternatively, other embodiments are disclosed wherein the means for indicating comprises measurement indicia disposed on the plunger.

### BRIEF DESCRIPTION OF THE DRAWING FIGURES

FIG. 1 is a bottom perspective view of a bottle in accordance with the disclosure, with a dispenser in a lowered position.

FIG. 2 is a bottom perspective view of the bottle of FIG. 1, with the dispenser in a raised position.

FIG. 3 is a top perspective view of the bottle of FIG. 1.

FIG. 4 is an exploded view of a bottle and a dispenser in accordance with the disclosure.

FIG. 5 is another exploded view of a bottle and a dispenser in accordance with the disclosure.

FIG. 6 is a top view of a bottle with the dispenser removed in accordance with the disclosure.

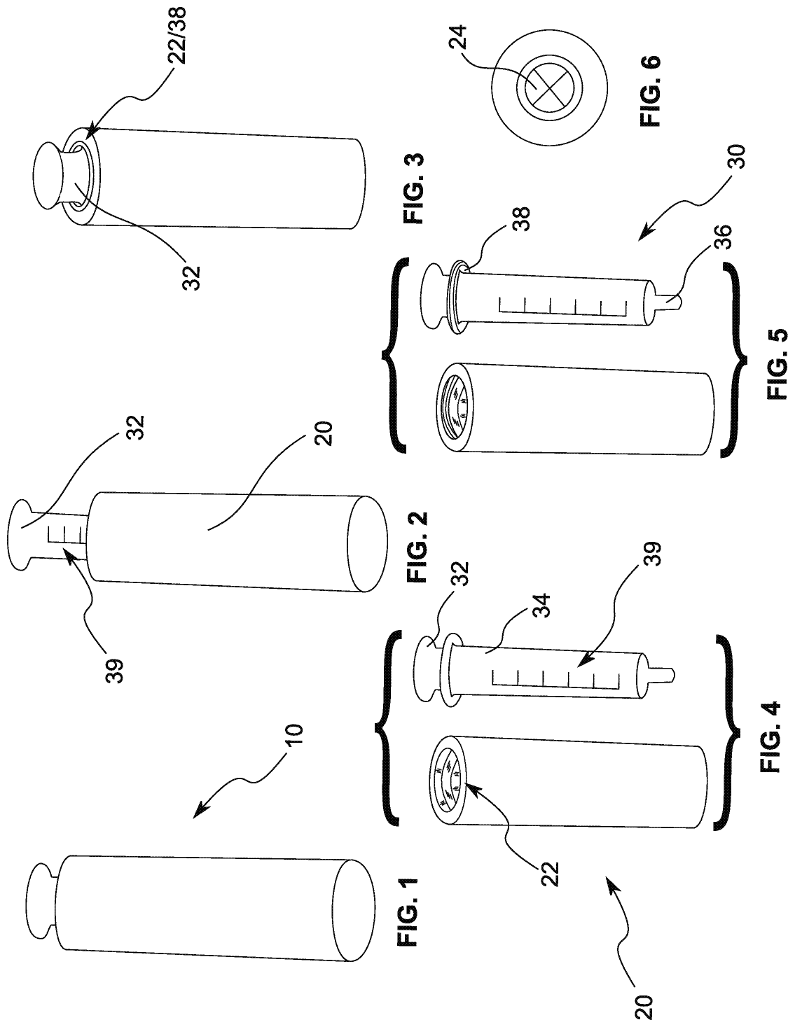

### DETAILED DESCRIPTION

The following detailed description and the appended drawings describe and illustrate some embodiments of the disclosed subject matter for the purpose of enabling one of ordinary skill in the relevant art to make and use these embodiments. As such, the detailed description and illustrations of these embodiments are purely illustrative in nature and are in no way intended to limit the scope of the disclosure in any manner. It should also be understood that the drawing figures are not necessarily to scale, and that in certain instances details (which may not be necessary for an understanding of the embodiments) may have been omitted, such as details of fabrication and assembly. In the accompanying drawing figures, like numerals represent like components.

With reference now to the drawing figures, a bottle 10 may include a reservoir 20 and a lid or cap with a built-in or integrated dispenser 30. In the context of the present disclosure, the term “bottle” is intended to mean a bottle, jar, decanter, vial, or other vessel for holding liquid; this may include flasks, carafes, cruets, ewers, and the like. In that regard, the shape of bottle 10 is depicted by way of illustration only, and not by way of limitation. It is noted, however, that even in light of the foregoing generalities, a bottle 10 that is constructed and operative for use in connection with an integrated dispensing apparatus as set forth herein may generally be sized and dimensioned such that a lid or cap may engage an open end 22 of reservoir 20 substantially as described below.

Bottle 10 and dispenser 30 may be constructed of glass, ceramic, polyvinyl chloride (PVC) or other plastics or polymers, metal (such as stainless steel or nickel alloys) other material suitable for holding liquid in reservoir 20 and dispensing same using dispenser 30; bottle 10 and dispenser 30 may be constructed of different materials, as desired, which may be selected as a function of the liquid to be stored and dispensed or may otherwise be application-specific. For medicinal or culinary uses, for example, it may be desirable to construct bottle 10, dispenser 30, or both of surgical or stainless steel or a low thermal expansion glass (such as Pyrex™, for instance) to accommodate autoclaving or other high temperature or chemical-based disinfection processes. The present disclosure is not intended to be limited by any specific type of material employed for the structure of bottle 10, reservoir 20, or dispenser 30, or for any coatings, sealants, or other surface treatments of these components.

In some implementations, dispenser 30 may function in a manner similar to that of a syringe, in that dispenser 30 may include an internal plunger (not illustrated) with a plunger head 32, a tube or cavity 34 in which the plunger reciprocates, and a dropper tip or nozzle 36 extending from tube 34 opposite plunger head 32. Tube 34 may also include an attachment portion 38 designed to engage with reservoir 20, as illustrated in the drawing figures and described herein, and may also serve as a leverage point for a user's fingers as the user pulls plunger head 32 longitudinally with respect to tube 34 in order to extract liquid. Markings or other indicia 39 may be provided (e.g., along tube 34, the internal plunger, or both) to ensure an accurate measurement of liquid to be extracted from reservoir 20.

Reservoir 20 may include an open top or opening 22 dimensioned and designed to engage with dispenser 30, specifically, with tube 34, attachment portion 38, or both. In one embodiment, opening 22 may be dimensioned to conformingly fit (i.e., “friction fit”) or engage with tube 34 at attachment portion 38, which may be releasably secured through push-fit, via cooperating ribs and depressions, or other detent mechanisms generally known in the art of friction fitting components together. In another embodiment, opening 22 may have internal threading which is matable with external threading provided on attachment portion 38 or tube 34. Further embodiments may include latches provided on attachment portion 38 and/or opening 22 which may engage upon rotation of the structure of dispenser 30. These various engagement mechanisms may result in child tamper-proofing bottle 10 and its contents, thereby improving safety.

Reservoir 20 may include a wiping or squeegee mechanism, such as wipe 24, to clean external liquid residue from the dispenser 30. As illustrated, wipe 24 may be embodied in or comprise flexible wedges, made from rubber, silicone, or other suitably malleable material, for example, that are positioned and sized to wipe or scrape tube 34 as dispenser 30 is withdrawn, thereby reducing an amount of residue liquid which might otherwise remain on an exterior wall or surface of tube 34 as dispenser 30 is removed from reservoir 20. Wedges 24 may contact one another after dispenser 30 is removed, thereby sealing reservoir 20 even after dispenser 30 has been removed. In another embodiment, wipe 24 may be implemented as or comprise an O-ring dimensioned to contact an exterior wall or surface of tube 34, thereby scraping residue as dispenser 30 is withdrawn from reservoir.

In some applications, bottle 10 may be packaged and sold with reservoir 20 pre-engaged with dispenser 30. A user may extract liquid from bottle 10 by engaging dispenser 30, such as by pulling plunger head 32 to a determined or desired longitudinal position (relative to tube 34) corresponding with a measured dose of liquid, thus causing the plunger to draw a measured amount of liquid into tube 34 from reservoir 20. The user may then remove dispenser 30 from reservoir 20 as described herein, and administer the measured dose of liquid by pushing or urging plunger cap 32 longitudinally towards nozzle 36. Dispenser 30 may then be returned to reservoir 20 for future use.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application, and publication cited or described in this document is hereby incorporated herein by reference in its entirety.

The foregoing description of possible implementations consistent with the present disclosure does not represent a comprehensive list of all such implementations or all variations of the implementations described. The description of some implementations should not be construed as an intent to exclude other implementations. For example, those of skill in the art will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the foregoing description be considered as illustrative, with a true scope and spirit of the disclosure being indicated by the following claims.

What is claimed is:

1. A bottle comprising:
a reservoir for storing liquid, the reservoir having an open top; and
a cap dimensioned and operative to engage the open top of the reservoir such that the cap prevents liquid from escaping the reservoir when the cap is engaged; and
a dispenser integrated with a structure of the cap, the dispenser comprising: a plunger; and a tube having a distal end to receive the plunger and a nozzle opposite the distal end; wherein the tube is the dimensioned to extend from the structure of the cap through the open top and into the reservoir, and wherein the plunger reciprocates in the tube, selectively to draw liquid from the reservoir when the plunger is moved away from the nozzle and selectively to dispense liquid from the tube when the cap is disengaged from the open top and the plunger is moved towards the nozzle.

2. The bottle of claim 1 wherein the cap comprises an attachment portion to engage the open top of the reservoir.

3. The bottle of claim 2 wherein the tube comprises the attachment portion.

4. The bottle of claim 2 wherein the attachment portion engages the open top of the reservoir via friction fit.

5. The bottle of claim 2 wherein the attachment portion comprises threads operative to engage cooperating threads on the open top of the reservoir.

6. The bottle of claim 1 wherein the tube comprises indicia to indicate an amount of liquid in the tube.

7. The bottle of claim 1 wherein the plunger comprises indicia to indicate an amount of liquid in the tube.

8. The bottle of claim 1 wherein the reservoir and the tube respectively are constructed of a material selected from one of the following: glass; metal; ceramic; and plastic.

9. The bottle of claim 1 further comprising a wiping mechanism to remove excess liquid from the tube when the dispenser is removed from the reservoir.

10. The bottle of claim 9 wherein the wiping mechanism is integrated into a structure of the reservoir.

11. The bottle of claim 10 wherein the wiping mechanism comprises flexible wedges dimensioned to engage an exterior wall of the tube.

12. The bottle of claim 10 wherein the wiping mechanism comprises an o-ring dimensioned to engage an exterior wall of the tube.

13. The bottle of claim 10 wherein the wiping mechanism is constructed of rubber.

14. The bottle of claim 10 wherein the wiping mechanism is constructed of silicone.

15. A bottle comprising:
a reservoir for storing liquid, the reservoir having an open top; and
a cap dimensioned and operative to engage the open top of the reservoir such that the cap prevents liquid from escaping the reservoir when the cap is engaged; and
a dispenser integrated with a structure of the cap, the dispenser comprising:
means for drawing liquid from the reservoir and for dispensing liquid when the dispenser is disengaged from the open top of the reservoir; and
means for indicating an amount of liquid that has been drawn from the reservoir.

16. The bottle of claim 15 wherein the means for drawing and for dispensing comprises: a plunger; and a tube having a distal end to receive the plunger and a nozzle opposite the distal end; wherein the tube is the dimensioned to extend from the structure of the cap through the open top and into the reservoir, and wherein the plunger reciprocates in the tube, selectively to draw liquid from the reservoir when the plunger is moved away from the nozzle and selectively to dispense liquid from the tube when the plunger is moved towards the nozzle.

17. The bottle of claim 15 wherein the cap comprises attachment means to engage the open top of the reservoir.

18. The bottle of claim 17 wherein the attachment means comprises threads operative to engage cooperating threads on the open top of the reservoir.

19. The bottle of claim 16 wherein the means for indicating comprises measurement indicia disposed on the tube.

20. The bottle of claim 16 wherein the means for indicating comprises measurement indicia disposed on the plunger.
